(19) United States
(12) Patent Application Publication
(10) Pub. No.: US 2004/0142726 A1
(43) Pub. Date: Jul. 22, 2004

(54) Method for controlling and interacting with a mobile device

(76) Inventors: Tal Dayan, Los Gatos, CA (US); Dan Kikinis, Saratoga, CA (US); Victor C. Su, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/701,243

(22) Filed: Nov. 3, 2003

Related U.S. Application Data
(60) Provisional application No. 60/423,027, filed on Nov. 1, 2002.

(51) Int. Cl. H04M 1/00

(52) U.S. Cl. 455/557; 455/574

(57) ABSTRACT

A surface management system exchanging information with a power management system of a device, thus allowing the two systems to communicate. A semiconductor chip that includes an integrated power control functionality to reduce pin count for multiple voltages in a multi-system environment.

This application claims priority to related provisional application No. 60/423,027 filed Nov. 1, 2002 titled “Method For Controlling And Interacting With A Mobile Device” (Attorney Docket No. 6041.P012z), and is herein incorporated by reference.

### BACKGROUND

In some situations, it may be advantageous for the surface to be able to talk, control, interact and monitor the device. In particular, the device may have a predictive behavior. For example, a cell phone may increase its power consumption when a call arrives; or a notebook may increase its power consumption when the user lifts lid. Therefore, in situations where multiple devices share one power supply, having advanced notice of such events may help the surface or its controller and power supply to better manage such events.

What is clearly needed is a method and a system that gives the surface management system the ability to exchange information with a power management system of a device, thus allowing the two systems to communicate.

What is further clearly needed is the ability to better integrate power control functionality into a semiconductor chip, thereby reducing pin count for multiple voltages in such a multi-system environment.

### DESCRIPTION OF THE EMBODIMENT

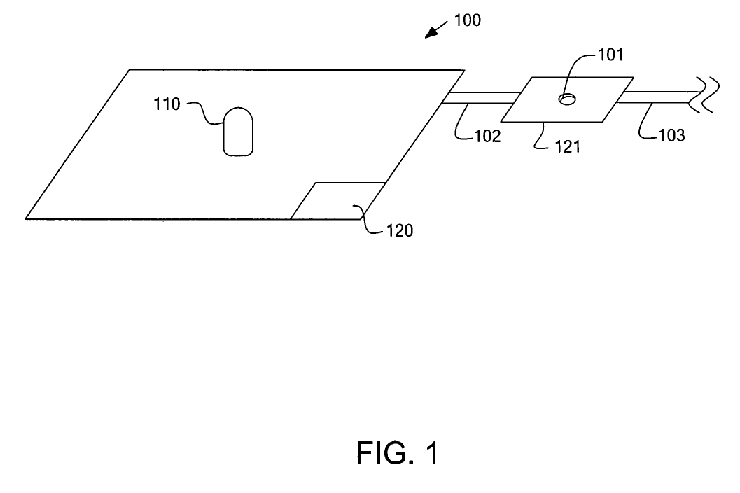

FIG. 1 shows a simplified view of a surface 100 with a cell phone 110 as an example device; and

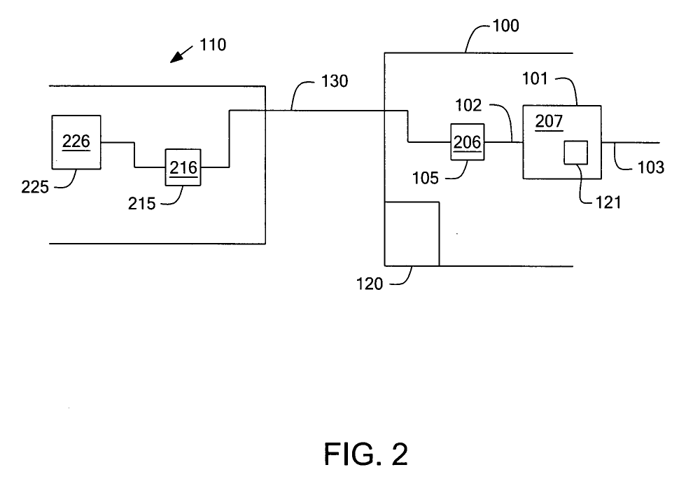

FIG. 2 shows a simplified flow diagram of the novel system disclosed in FIG. 1.

### DESCRIPTION OF THE EMBODIMENT

FIG. 1 shows a simplified view of a surface 100 with a cell phone 110 as an example device. Surface 100 connects to a power supply and/or a power supply controller 101 through a cable 102, and supply 101 thence connects to an external power source (not shown) via a cable 103. In addition, some user interface indicators and sensors may be integrated into area 120 and/or area 121. Such additional user interface indicators and sensors of areas 120 and 121 may include LEDs or other indicators showing the status of the system, warning lights, etc., or sensors checking for ambient parameters such as temperature, brightness, etc. Also included may be one or more microphones and/or speakers, etc. The indicators and sensor of areas 120 and 121 may then alert the user to a variety of events and conditions. For example, if the user has turned off the ringer of the cell phone, an indicator in area 120 or 121 may flash to alert him to an incoming call. As another example, if some problem occurs when the user requests simultaneous powering of a notebook and a cell phone, a red light may turn on to indicate an error condition. In other cases, instead of an LED, the indicator in area 120 or 121 may be an LCD text display, or an audio message may be broadcast from the speaker, such as, for example, “You have added a second device that is not compatible. I can power only one device at a time.” In some cases, voice recognition may be used to control such parameters, as for the settings of the pad control, i.e. to turn of the sound of the phone when it is dark in the room etc.

FIG. 2 shows a simplified flow diagram of the novel system disclosed in FIG. 1. Surface 100 contains area 120 for sensors and indicators, and is connected to power supply 101, which contains area 121 for sensors and indicators. Also shown is a controller 105 between the power supply 101 and the device connection (i.e., contacts) 130. Controller 105 contains software 206, which is able to negotiate with an intelligent controller on the device side. Device 110 contains a controller 215, which has software code 216, which, when executed, communicates with the main CPU 225, which contains a code segment 226 for articulating the power requirements of the device. It is clear that in some cases these intermediate processors 215 and 105 may be eliminated, and said software 216 and 206, respectively, may be integrated into the main units 225 and 101, respectively. Any kind of variation, including one or more additional processors, may also be incorporated into the system without departing from the spirit of the novel art of this disclosure.

In some cases, interaction may not be so directly, but by monitoring other aspects, i.e. the base may be monitoring behavior of the device and deduct status information from it. For example, certain RF patterns may indicate a ring or certain power patters may indicate a device that is turned off. Other things, such as changes in power consumption signatures etc may also be used.

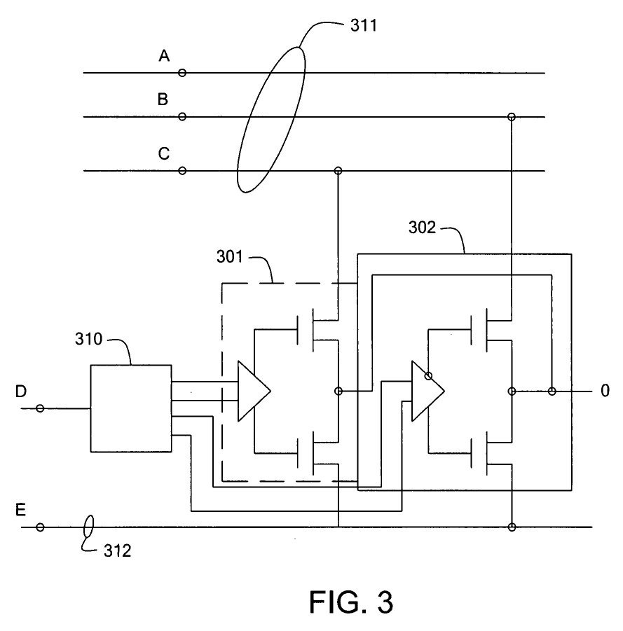

FIG. 3 shows an integration of multiple half-bridge cells as described earlier filed applications that are included herein in the attached Appendices A through K, which are incorporated herein by reference. Multiple power arrays A, B, and C comprise power array group 311. A ground rail 312 is at point E. Rather having each cell connect to all the rails, and an IO pin to drive a contact, half-bridge cells 301, 302 and possible additional cells are connected to output O (driving a contact, in some case as an IO) and are controlled by controller 310. By this approach, a large number of multiple cells in one Integrated Circuit may dramatically reduce the overall number of pins required to connect a given number of contacts. This pin reduction is important in particular because port D on above mentioned controller 310 may have a serial port of some sort to turn on and off power. That port may also be able to include communication for recognition and power management as discussed above.

The techniques of the invention as previously discussed may be implemented, and/or used in conjunction with, the technical specifications as discussed in the attached in Appendices A-K, which are also incorporated herein by reference.

In the claims:

1) a method comprising:
a surface management system exchanging information with a power management system of a device, to allow the two systems to communicate.

2) An apparatus comprising:
a semiconductor chip that includes an integrated power control functionality to reduce pin count for multiple voltages in a multi-system environment.
